(19) United States
(12) Patent Application Publication
(10) Pub. No.: US 2016/0167465 A1
(43) Pub. Date: Jun. 16, 2016

(54) ON-WHEEL AIR MAINTENANCE SYSTEM

(71) Applicant: The Goodyear Tire & Rubber Company, Akron, OH (US)

(72) Inventor: Daniel Paul Luc Marie Hinque, Habay-la-Neuve (BE)

(21) Appl. No.: 14/607,897

(22) Filed: Jan. 28, 2015

Related U.S. Application Data
(60) Provisional application No. 62/091,143, filed on Dec. 12, 2014.

(51) Int. Cl. B60C 23/12; B60C 23/00

(52) U.S. Cl. CPC B60C 23/12; B60C 23/001

(57) ABSTRACT

An air maintenance system includes a rotating inner ring secured to a vehicle wheel, a stationary outer ring maintaining a constant angular position, an eccentric mass secured to the stationary outer ring, an occlusion roller located proximate to the eccentric mass, and a flexible tube defining a pump cavity. The air maintenance system pumps a fluid from the ambient environment into a pneumatic tire by applying an occluding force against the flexible tube, periodically occluding portions of the pump cavity.

### TECHNICAL FIELD

The present invention relates generally to the automotive field, and more specifically, to a new and useful tire air maintenance system in the automotive field.

### BACKGROUND OF THE PRESENT INVENTION

Non-optimally pressurized pneumatic tires contribute to low fuel efficiency. These effects are particularly felt in the trucking industry, where long distances and large loads amplify the effects of an underinflated tire. However, it is often inconvenient and inefficient for truck drivers to constantly stop, check, and inflate the vehicle tires to the optimal pressure, leading to the persistence of less-than-optimal fuel efficiency in truck fleets. This challenge has led to several conventional auto-inflating tire systems. Conventional auto-inflating tire systems may be either central or distributed, but each suffers from its own set of drawbacks. Central inflation systems are complex and expensive, and require significant work for aftermarket installation (drilling through axles, tapping existing air lines, etc.). Distributed systems are mounted at each wheel and can be less expensive, but the potential for reduced cost is typically at the expense of the continuous replacement of the device (which fails due to the harsh wheel environment). Thus, there is a need in the automotive field to create a new and useful air maintenance system for pneumatic tires.

### SUMMARY OF THE INVENTION

An air maintenance system in accordance with the present invention includes a rotating inner ring secured to a vehicle wheel, a stationary outer ring maintaining a constant angular position relative to the vehicle wheel, an eccentric mass secured to the stationary outer ring, an occlusion roller located proximate to the eccentric mass, and a flexible tube defining a pump cavity. The air maintenance system pumps a fluid from the ambient environment into a pneumatic tire by applying an occluding force against the flexible tube, periodically occluding portions of the pump cavity.

According to another aspect of the system, the rotating inner ring rotates relative to the eccentric mass.

According to still another aspect of the system, relative diameters between the inner rotating ring and roller elements of the stationary outer ring collaborate to achieve a desired gear ratio and pumping speed.

According to yet another aspect of the system, the inner rotating ring provides a smooth bearing surface for the roller elements and the occlusion roller.

According to still another aspect of the system, the stationary outer ring encircles the air maintenance system and applies an inward radial force against the roller elements and occlusion roller when assembled.

According to yet another aspect of the system, the inward radial force maintains the inner rotating ring and the roller elements.

According to still another aspect of the system, the inner rotating ring has a substantially homogeneous weight distribution such that no portion of the inner rotating ring is substantially heavier than another portion.

According to yet another aspect of the system, the inner rotating ring is substantially rigid and made of metal.

According to still another aspect of the system, the inner rotating ring is made of a rigid polymer.

According to yet another aspect of the system, the eccentric mass overcomes inertia and friction generated by rotation of the inner rotating ring and rotating wheel such that the eccentric mass stays substantially static while the inner rotating ring rotates.

According to still another aspect of the system, the eccentric mass maintains the angular position of the eccentric mass relative to a road surface as the vehicle wheel rotates and provides torque, generated by gravity, that opposes the rotation of the inner rotating ring with the vehicle wheel.

According to yet another aspect of the system, the eccentric mass prevents the outer stationary ring from rotating with the vehicle wheel and the inner rotating ring.

According to still another aspect of the system, the eccentric mass is rectangular.

According to yet another aspect of the system, the eccentric mass is spherical.

According to still another aspect of the system, the roller elements retain non-slip contact between the roller elements and the inner rotating ring.

According to yet another aspect of the system, there are three roller elements.

According to still another aspect of the system, the flexible tube defines a deformable interface that occludes the pump cavity.

According to yet another aspect of the system, the flexible tube has an oval cross section.

According to still another aspect of the system, the flexible tube comprises a flexible, elastomeric material.

According to yet another aspect of the system, the flexible tube includes an inlet port and an outlet port each in fluid connection with a pressure regulator assembly.

### DEFINITIONS

“Apex” refers to a wedge of rubber placed between the carcass and the carcass turnup in the bead area of the tire, usually used to stiffen the lower sidewall of the tire.

“Axial” and “axially” means lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt reinforcing structure” means at least two layers of plies of parallel cords, woven or unwoven, underlying the tread, unanchored to the bead, and having both left and right cord angles in the range from 17 degrees to 27 degrees with respect to the equatorial plane of the tire.

“Bias ply tire” means a tire having a carcass with reinforcing cords in the carcass ply extending diagonally across the tire from bead core to bead core at about a 25 to 50 degree angle with respect to the equatorial plane of the tire. Cords run at opposite angles in alternate layers.

“Breakers” refers to at least two annular layers or plies of parallel reinforcement cords having the same angle with reference to the equatorial plane of the tire as the parallel reinforcing cords in carcass plies.

“Carcass ply” means the tire structure apart from the belt structure, tread, undertread, sidewall rubber and the beads.

“Chafers” refers to narrow strips of material placed around the outside of the bead to protect cord plies from the rim, distribute flexing above the rim, and to seal the tire.

“Cord” means one of the reinforcement strands of which the plies in the tire are comprised.

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization—Standards Manual and the term design rim means the same as the standard measurement rims. In Japan, the standard organization is The Japan Automobile Tire Manufacturer's Association.

“Design rim width” is the specific commercially available rim width assigned to each tire size and typically is between 75 and 90% of the specific tire's section width.

“Equatorial plane (EP)” means the plane perpendicular to the tire's axis of rotation and passing through the center of its tread.

“Filament” refers to a single yarn.

“Footprint” means the contact patch or area of contact of the tire tread with a flat surface at zero speed and under normal load and pressure.

“Innerliner” means the layer or layers of elastomer or other material that form the inside surface of a tubeless tire and that contain the inflating fluid within the tire.

“Lateral edge” means the axially outermost edge of the tread as defined by a plane parallel to the equatorial plane and intersecting the outer ends of the axially outermost traction lugs at the radial height of the inner tread surface.

“Leading” refers to a portion or part of the tread that contacts the ground first, with respect to a series of such parts or portions, during rotation of the tire in the direction of travel.

“Molded base width” refers to the distance between the beads of the tire in the curing mold. The cured tire, after removal from the curing mold will substantially retain its molded shape, and “molded base width” may also refer to the distance between the beads in an unmounted, cured tire.

“Net contact area” means the total area of ground contacting tread elements between the lateral edges.

“Nominal rim diameter” means the average diameter of the rim flange at the location where the bead portion of the tire seats.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Pantographing” refers to the shifting of the angles of cord reinforcement in a tire when the diameter of the tire changes, e.g. during the expansion of the tire in the mold.

“Ply” means a continuous layer of rubber-coated parallel cords.

“Pneumatic tire” means a mechanical device of generally toroidal shape (usually an open torus) having beads and a tread and made of rubber, chemicals, fabric and steel or other materials. When mounted on the wheel of a motor vehicle, the tire, through its tread, provides a traction and contains the fluid or gaseous matter, usually air, that sustains the vehicle load.

“Radial” and “radially” means directions radially toward or away from the axis of rotation of the tire.

“Radial-ply tire” means a belted or circumferentially restricted pneumatic tire in which the ply cords which extend from bead to bead are laid at cord angles between 65 to 90 degrees with respect to the equatorial plane of the tire.

“Rhoₘ” refers to the perpendicular distance from the axis of rotation of a tire to a line parallel to the axis of rotation which passes through the maximum section width of the tire.

“Section height” (SH) means the radial distance from the nominal rim diameter to the outer diameter of the tire at its equatorial plane.

“Section width” (SW) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Shoulder” means the upper portion of a sidewall just below the tread edge.

“Sidewall” means that portion of a tire between the tread and the bead.

“Splice” refers to the connection of end of two components, or the two ends of the same component in a tire. “Splice” may refer to the abutment or the overlapping of two such ends.

“Strain energy density” refers to the summation of the product of the six stress components (three normal stresses and three shear stresses) and their corresponding strains.

“Tire design load” is the base or reference load assigned to a tire at a specific inflation pressure and service condition: other load-pressure relationships applicable to the tire are based upon that base or reference.

“Tread” means a molded rubber component which, when bonded to a tire casing, includes that portion of the tire which comes into contact with the road when the tire is normally inflated and under normal load.

“Tread arc width” (TAW) means the width of an arc having its center located on the plane (EP) and which substantially coincides with the radially outermost surfaces of the various traction elements (lugs, blocks, buttons, ribs, etc.) across the lateral or axial width of the tread portions of a tire when the tire is mounted upon its designated rim and inflated to its specified inflation pressure but not subjected to any load.

“Tread width” means the arc length of the tread surface in the axial direction, that is, in a plane passing through the axis of rotation of the tire.

“Unit tread pressure” means the radial load borne per unit area (square centimeter or square inch) of the tread surface when that area is in the footprint of the normally inflated and normally loaded tire.

“Wedge” refers to a tapered rubber insert, usually used to define individual curvature of a reinforcing component, e.g. at a belt edge.

### BRIEF DESCRIPTION OF DRAWINGS

The present invention will be described by way of example and with reference to the accompanying drawings, in which:

FIG. 1 schematically illustrates a cross-sectional view of an air maintenance assembly in accordance with the present invention.

FIG. 2 schematically illustrates a perspective view of part of the assembly of FIG. 1.

FIG. 3 schematically illustrates a perspective view of another part of the assembly of FIG. 1.

FIG. 4 schematically illustrates a perspective view of part of the air maintenance assembly of FIG. 1.

FIG. 5 schematically illustrates a perspective view of another part of the air maintenance assembly of FIG. 1.

FIGS. 6A, 6B and 6C schematically illustrates a perspective view of still another part of the air maintenance assembly of FIG. 1.

FIGS. 7A and 7B schematically illustrates a perspective view of yet another part of the air maintenance assembly of FIG. 1.

FIGS. 8A, 8B and 8C schematically illustrates a perspective view of still another part of the air maintenance assembly of FIG. 1.

FIG. 9 schematically illustrates a perspective view of yet another part of the air maintenance assembly of FIG. 1.

FIG. 10 schematically illustrates a perspective view of still another part of the air maintenance assembly of FIG. 1.

FIGS. 11A and 11B schematically illustrates a perspective view of yet another part of the air maintenance assembly of FIG. 1.

FIG. 12 schematically illustrates a perspective view of still another part of the air maintenance assembly of FIG. 1.

FIG. 13 schematically illustrates a perspective view of yet another part of the air maintenance assembly of FIG. 1.

FIG. 14 schematically illustrates a perspective view of still another part of the air maintenance assembly of FIG. 1.

### DETAILED DESCRIPTION OF EXAMPLES OF THE PRESENT INVENTION

A conventional tire inflation system may mount to the wheel of a vehicle. The tire inflation system may include a pumping ring that rotates with the wheel and a positioning system rotatably coupled to the wheel. The positioning system may include a positioning mechanism and an eccentric mass. A planetary roller may be disposed in non-slip contact with the pumping ring and the positioning system. A flexible diaphragm may define a pump cavity wherein relative motion between the pumping ring and positioning system may be translated by the planetary roller into an occluding force that deforms the diaphragm and thereby occludes the pump cavity. Relative motion between the pumping ring and the positioning system may be achieved by coupling the eccentric mass to the positioning mechanism to offset the center of mass of the positioning system from the center of rotation of the positioning system. Such a system has been disclosed by U.S. Pat. No. 8,763,661, incorporated herein by reference in its entirety.

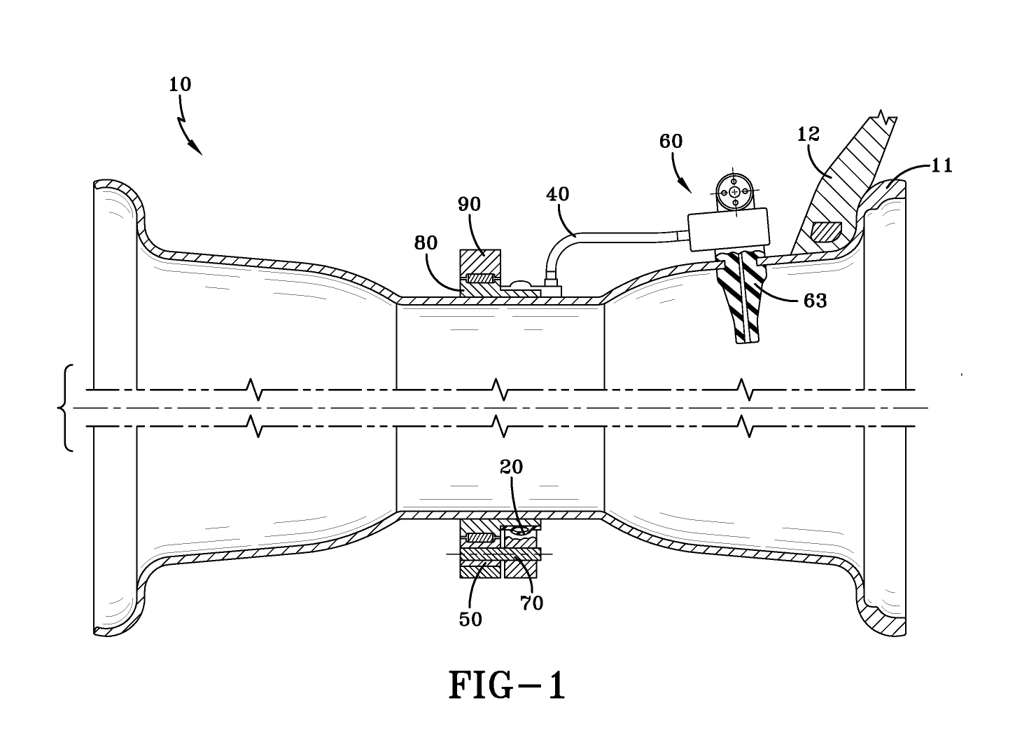

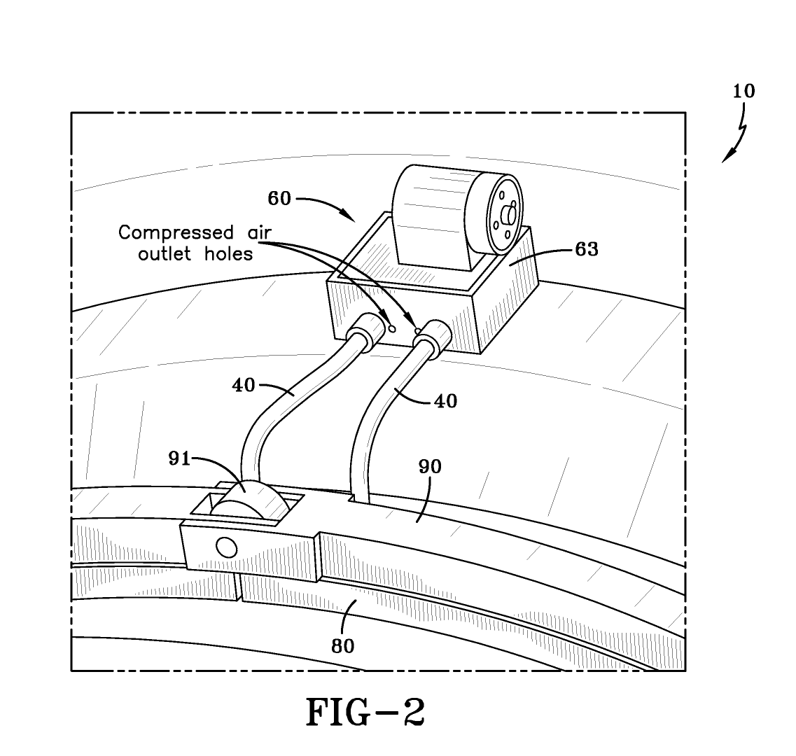

As shown in FIGS. 1-3, an air maintenance system 10 in accordance with the present invention may include a rotating inner ring 80, a stationary outer ring 90, an eccentric mass 50, an occlusion roller 70 located proximate to the eccentric mass, and a flexible tube 20 that defines a pump cavity. The air maintenance system 10 may be coupled to a rotating wheel 11 wherein the rotating inner ring 80 rotates with the rotating wheel while the eccentric mass 50 maintains a constant angular position relative to the rotating wheel 11. This arrangement may thereby generate relative motion between the rotating inner ring 80 and the eccentric mass 50. The air maintenance system 10 may translate this relative motion into mechanical work or other energy forms. The air maintenance system 10 may pump a fluid from the ambient environment into a pneumatic tire 12 seat to the rotating wheel 11 by applying an occluding force against the flexible tube 20, periodically occluding portions of the pump cavity. The air maintenance system 10 may be coupled to the rim of the wheel 11, such as that of a truck, compact vehicle, motorcycle, bicycle and/or other vehicle.

The air maintenance system 10 may be a planetary system wherein the relative diameters between the inner rotating ring 80 and roller elements 91 collaborate to achieve the desired gear ratio and pumping speed. The pumping rate, pressure, and frequency may also be controlled with a passive or an active control mechanism.

The inner rotating ring 80 may apply an occluding force against the flexible tube 20. The inner rotating ring 80 also may provide a smooth bearing surface for the roller elements 91 and an occlusion roller 70, and may additionally contain or constrain other components of the air maintenance system 10. The inner rotating ring 80 may rotate with the rotating wheel 11, and may be statically, but removably, coupled to the rotating wheel.

An outer ring 90 may encircle the air maintenance system 10 and apply an inward radial force against the rollers 91 when assembled. This inward radial force may maintain the inner rotating ring 80 and the rollers 91. The inner rotating ring 80 may have a substantially homogeneous weight distribution such that no portion of the inner rotating ring is substantially heavier than another portion. The inner rotating ring 80 may be substantially rigid and made of metal (e.g. stainless steel, aluminum, titanium), but may alternately be made of a rigid polymer (e.g. polyacetylenes, polyfluroenes, nylon, and polyimides) or a ceramic.

The eccentric mass 50 may overcome the inertia and friction generated by the rotation of the inner rotating ring 80 and rotating wheel 11 such that the eccentric mass stays substantially static while the inner rotating ring rotates. Further, the eccentric mass 50 may be coupled to the air maintenance system 10 to maintain the angular position of the eccentric mass relative to the road surface (which is contacted by the wheel 11) as the wheel rotates and provides torque, generated by gravity, that opposes the rotation of the inner rotating ring 80 with the wheel. In other words, the eccentric mass 50 may prevent the outer ring 90 from rotating with the wheel 11 and the inner rotating ring. This relative motion, enabled by the gravitational pull on the eccentric mass 50 may harvested to do mechanical work.

This relative motion may occur because the center of mass of the eccentric mass 50 is not located at the center of rotation such that the pull of gravity on the eccentric mass may allow it to remain substantially static relative to the road surface while the inner rotating ring 80 rotates relative to the road surface. The weight of the eccentric mass 50 may be large enough to generate the amount of mechanical work desired, in addition to being large enough to overcome friction and adequately dampen induced oscillations resulting from non-rotating motion (e.g. from bumps). The eccentric mass 50 may be rectangular, spherical, or amorphous. The eccentric mass 50 may be made of metal, such as stainless steel, copper, aluminum, etc., but may alternately be made of plastic, ceramic, and/or a fluid/gel. The roller elements 91 may additionally retain non-slip contact between the roller elements and the inner rotating ring 80, but may not provide a direct occluding force. The air maintenance system 10 may include two, three, five, or any suitable number of rollers.

The flexible tube 20 may define the pump cavity that holds a fluid and a deformable interface that occludes the pump cavity. The flexible tube 20 may have a circular or oval cross section. The flexible tube 20 may comprise a flexible, elastomeric material such as rubber or thermosets, thermoplastics, or any other suitable material. The flexible tube 20 may include an inlet port 21 and an outlet port 22 each in fluid connection with tubes 40 and a pressure regulator assembly 60.

The pressure regulator assembly 60 may include a control valve, check valves, a filter, and an inlet port 61 for receiving ambient air. A housing 63 of the pressure regulator assembly 60 may be secured to the wheel 11 with the inlet port 61 located externally to the tire cavity of the tire 12 and the remaining structures of the pressure regulator assembly 60 located internally to the tire cavity (FIG. 1).

The air maintenance system 10 utilize a peristaltic or reciprocating pump method. In the peristaltic method, the occlusion roller 70 may constrict a portion the flexible tube 20 that is adjacent the occlusion roller thereby deforming the flexible tube segment by segment between an expanded condition and an at least partially collapsed condition in response to respective segment by segment deformation by the occlusion roller located, with the eccentric mass 50, by gravity statically at the bottom of the outer ring 90.

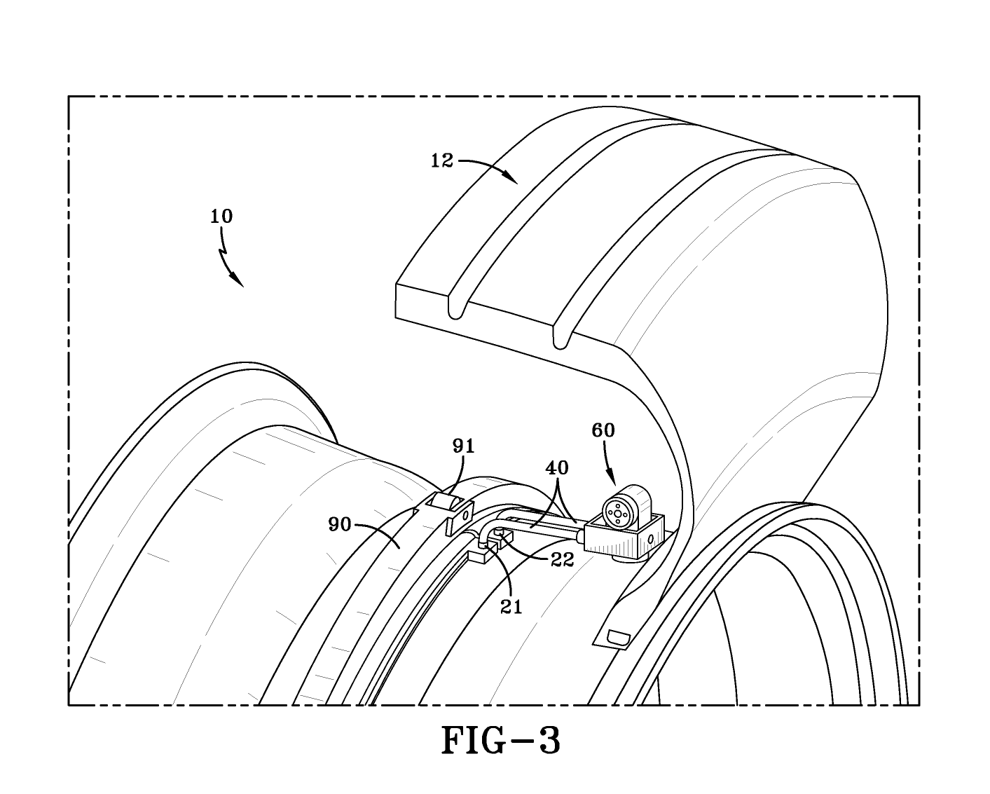

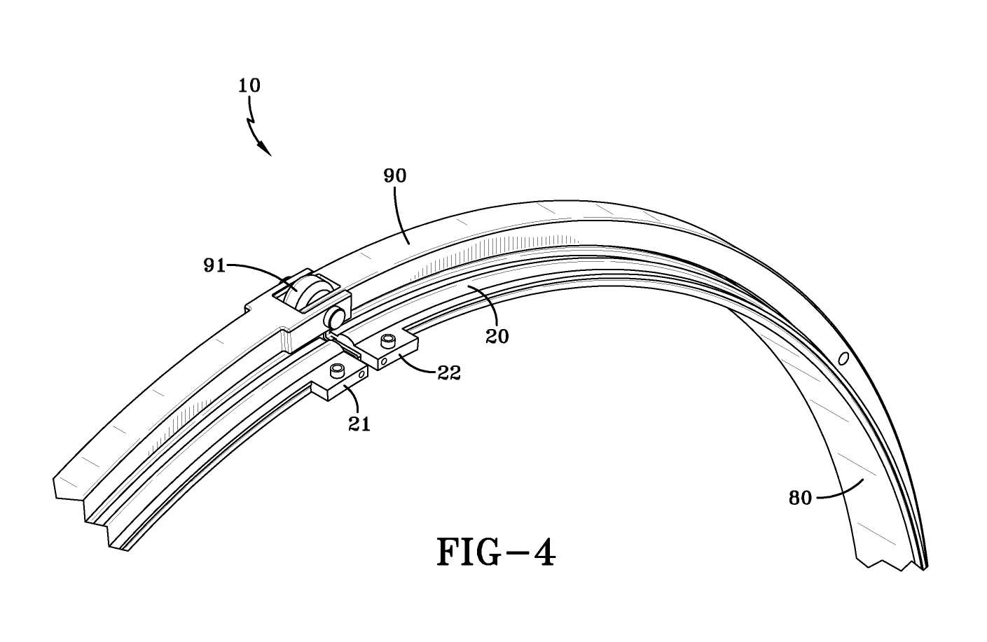

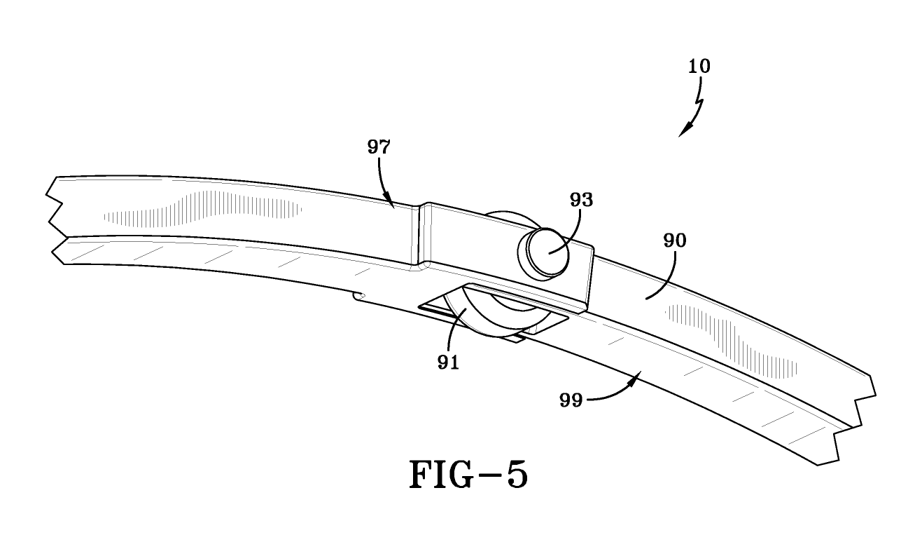

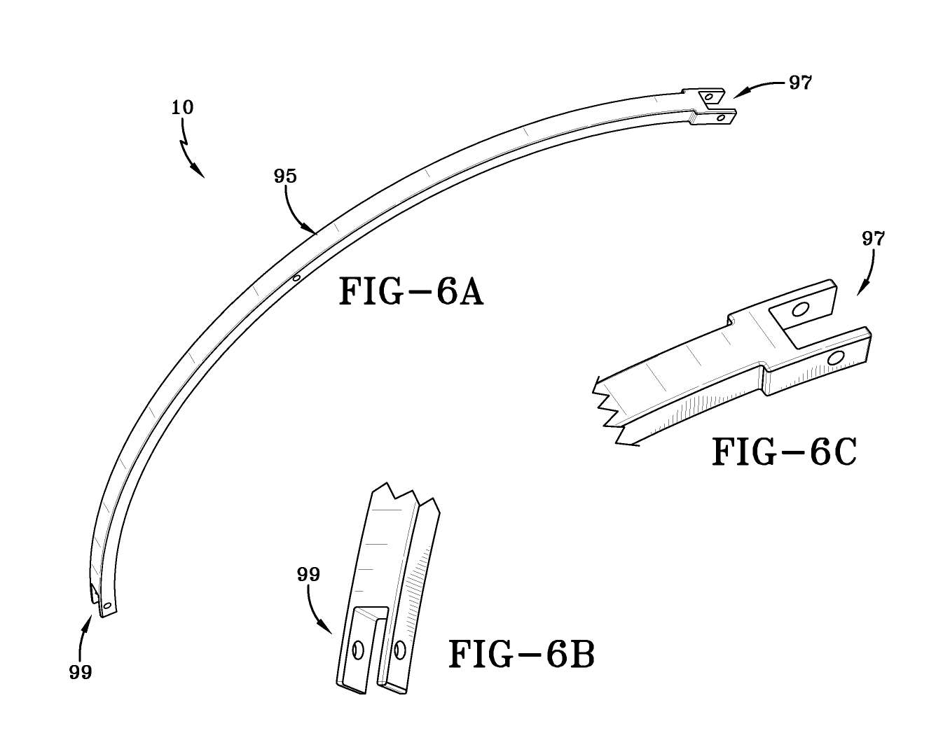

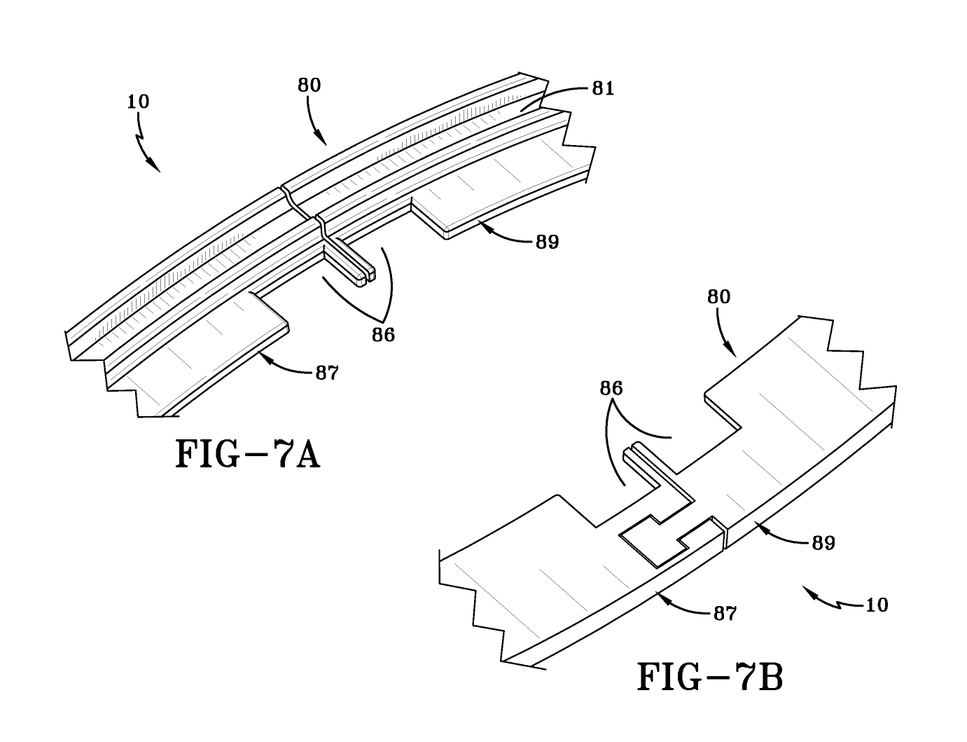

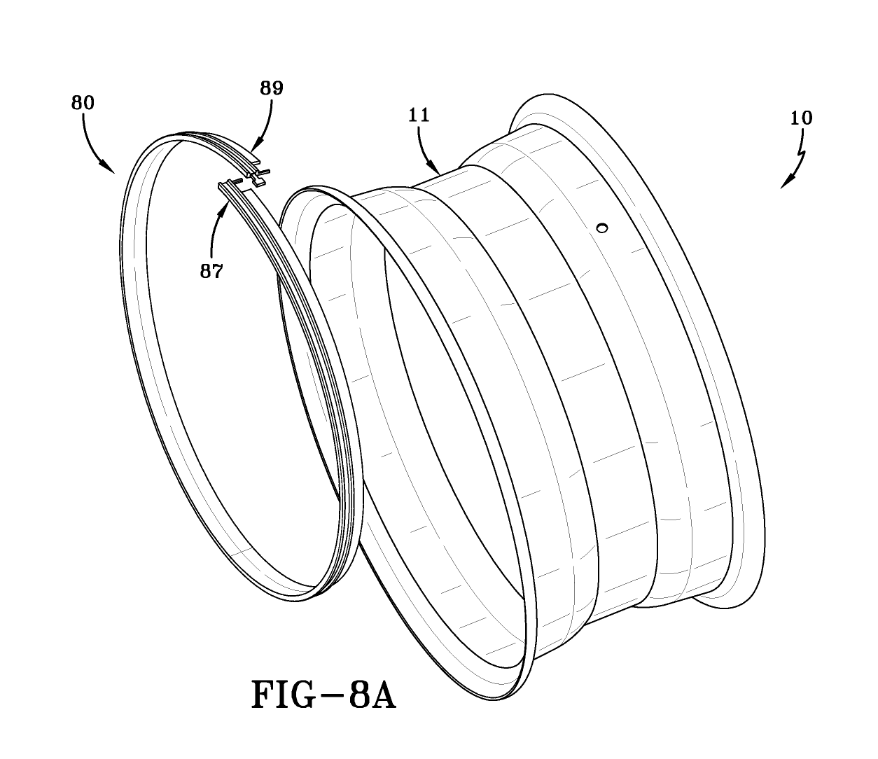

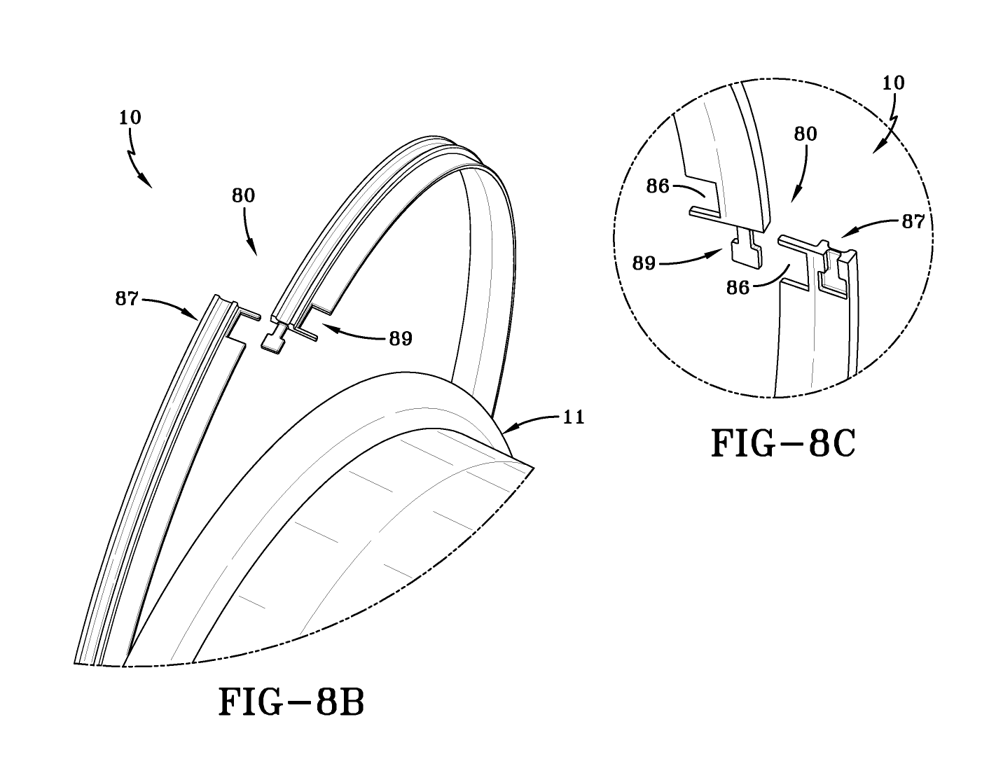

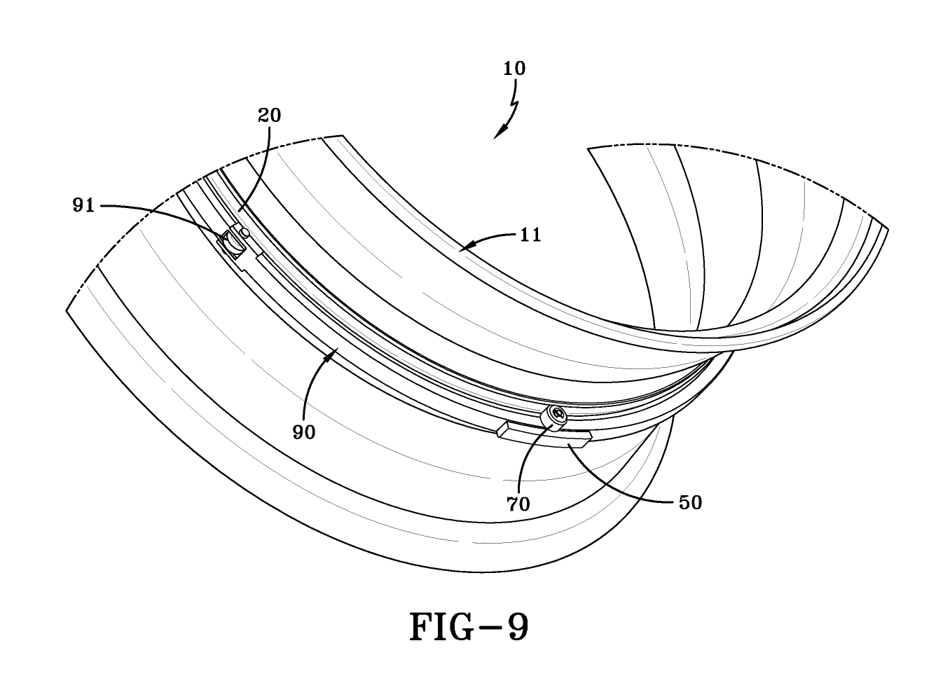

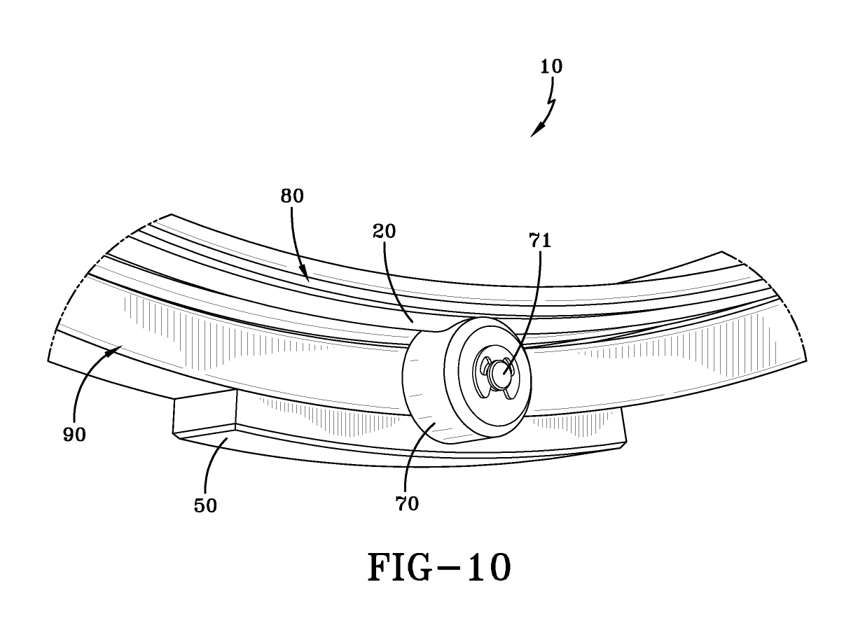

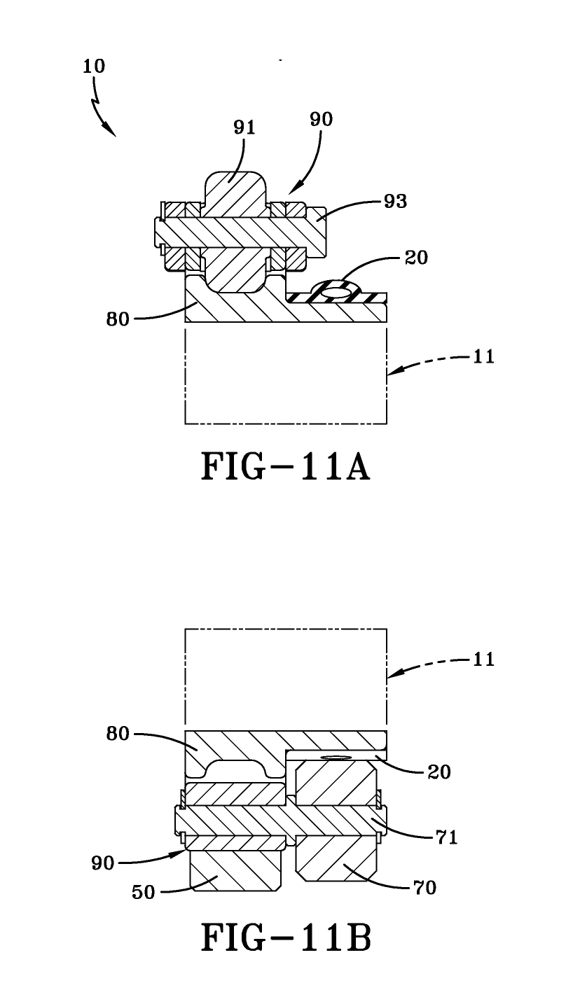

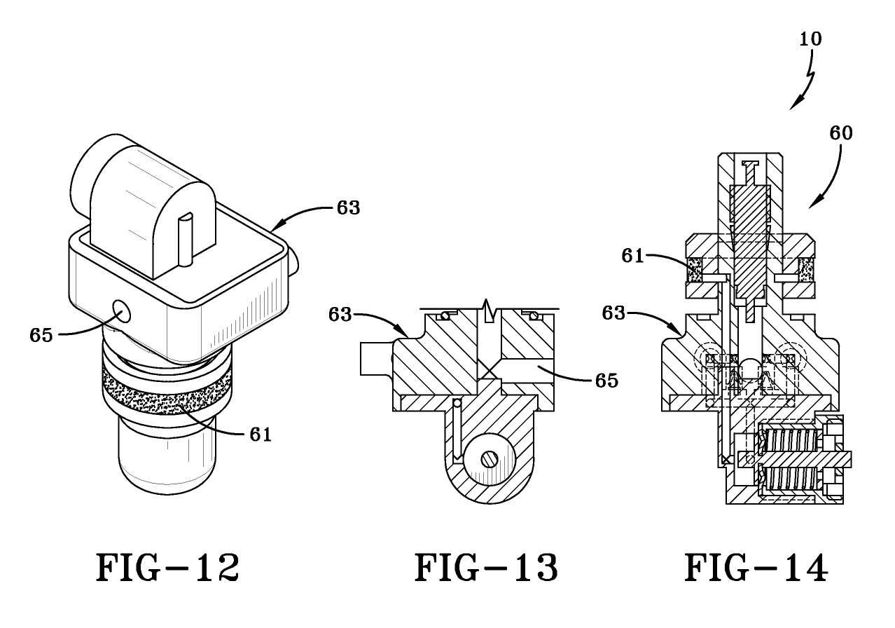

As shown in FIG. 4, the rotating inner ring 80 may be disposed concentrically in the stationary outer ring 90 with the roller elements 91 determining its orientation relative to the stationary outer ring. As shown in FIG. 5, the roller elements 91 may be rotatably secured to the stationary outer ring 90 by a shaft 93. As shown in FIG. 6, the stationary outer ring 90 may comprise a plurality of segments 95 (e.g., 3, 4, 5, etc.) a female mating connection at one end 97 and a male connection at its opposite end 99. As shown in FIG. 7, the rotating inner ring 80 may comprise a roller element track 81 for receiving the roller elements 91, a plurality of segments 85 (e.g., 1, 2, 3, 4, etc.) with a female recess at one end 87 for mating with a male clip connection at its opposite end 89. Each end 87, 89 may further have slots 86 for securing the flexible tube 20. As shown in FIG. 8, the rotating inner ring 80 may be secured to wheel 11 by connecting the ends 87, 89. As shown in FIGS. 9-10, the occlusion roller 70 may be rotatably attached to the stationary outer ring 90 by a shaft 71 such that the occlusion roller, held stationary by the eccentric mass 50, rolls and squeezes the flexible tube 20 as the rotating inner ring 80 and wheel 11 rotate. As shown in FIG. 11, the roller elements 91 may travel along the roller element track 81 and the occlusion roller 70 may sequentially squeeze the flexible tube 20 as the wheel 11 rotates. As shown in FIGS. 12-14, the housing 63 of the pressure regulator assembly 60 may include a fill port 65 for regular tire pressure maintenance (e.g., an initial air fill up, etc.).

As a person skilled in the art will recognize from the above detailed description and from the figures and claims, modifications and changes may be made to the examples of the present invention without departing from the scope of the present invention defined by the following claims.

1. An air maintenance system comprising:
a rotating inner ring secured to a vehicle wheel;
a stationary outer ring maintaining a constant angular position;
an eccentric mass secured to the stationary outer ring;
an occlusion roller located proximate to the eccentric mass; and
a flexible tube defining a pump cavity, the air maintenance system pumping a fluid from the ambient environment into a pneumatic tire by applying an occluding force against the flexible tube, periodically occluding portions of the pump cavity.

2. The air maintenance system as set forth in claim 1 wherein the rotating inner ring rotates relative to the eccentric mass.

3. The air maintenance system as set forth in claim 1 wherein relative diameters between the inner rotating ring and roller elements of the stationary outer ring collaborate to achieve a desired gear ratio and pumping speed.

4. The air maintenance system as set forth in claim 3 wherein the inner rotating ring provides a smooth bearing surface for the roller elements and the occlusion roller.

5. The air maintenance system as set forth in claim 4 wherein the stationary outer ring encircles the air maintenance system and applies an inward radial force against the roller elements when assembled.

6. The air maintenance system as set forth in claim 5 wherein the inward radial force maintains the inner rotating ring and the roller elements.

7. The air maintenance system as set forth in claim 1 wherein the inner rotating ring has a substantially homogeneous weight distribution such that no portion of the inner rotating ring is substantially heavier than another portion.

8. The air maintenance system as set forth in claim 1 wherein the inner rotating ring is substantially rigid and made of metal.

9. The air maintenance system as set forth in claim 1 wherein the inner rotating ring is made of a rigid polymer.

10. The air maintenance system as set forth in claim 1 wherein the eccentric mass overcomes inertia and friction generated by rotation of the inner rotating ring and rotating wheel such that the eccentric mass stays substantially static while the inner rotating ring rotates.

11. The air maintenance system as set forth in claim 1 wherein the eccentric mass maintains the angular position of the eccentric mass relative to a road surface as the vehicle wheel rotates and provides torque, generated by gravity, that opposes the rotation of the inner rotating ring with the vehicle wheel.

12. The air maintenance system as set forth in claim 1 wherein the eccentric mass prevents the outer stationary ring from rotating with the vehicle wheel and the inner rotating ring.

13. The air maintenance system as set forth in claim 1 wherein the eccentric mass is rectangular.

14. The air maintenance system as set forth in claim 1 wherein the eccentric mass is spherical.

15. The air maintenance system as set forth in claim 3 wherein the roller elements retain non-slip contact between the roller elements and the inner rotating ring.

16. The air maintenance system as set forth in claim 3 wherein there are three roller elements.

17. The air maintenance system as set forth in claim 1 wherein the flexible tube defines a deformable interface that occludes the pump cavity.

18. The air maintenance system as set forth in claim 1 wherein the flexible tube has a oval cross section.

19. The air maintenance system as set forth in claim 1 wherein the flexible tube comprises a flexible, elastomeric material

20. The air maintenance system as set forth in claim 1 wherein the flexible tube include an inlet port and an outlet port each in fluid connection with a pressure regulator assembly.
